(19) United States
(12) Patent Application Publication
(10) Pub. No.: US 2026/0340143 A1
(43) Pub. Date: Oct. 29, 2026

(54) AI AGENT-BASED TRAINING DATA LABELING FOR TRAINING MACHINE LEARNING MODELS TO SCORE ALERT GROUP RESOLUTION PLAN PRIORITIZATION

(71) Applicant: Palo Alto Networks, Inc., Santa Clara, CA (US)

(72) Inventors: Venkatesh Kumaran Pappakrishnan, Dublin, CA (US); Ruben Dario Torres Guerra, Menlo Park, CA (US); Alok Tongaonkar, San Jose, CA (US)

(21) Appl. No.: 19/192,531

(22) Filed: Apr. 29, 2025

(51) Int. Cl. G06F 21/57; G06N 20/00

(52) U.S. Cl. CPC G06F 21/577; G06N 20/00; G06F 2221/034

(57) ABSTRACT

An artificial intelligence (AI) framework has been created to efficiently label training data for training a machine learning model to score prioritization of alert group resolution plans to aid in triage of alert groups. An AI agent uses a labeled dataset of alert group resolution plans to tune its reasoning engine to score prioritization of alert group resolution plans. The AI agent tunes its reasoning engine by employing active learning until the prioritization scoring is sufficiently accurate. Upon achieving sufficient accuracy, the AI agent scores prioritization of an unlabeled dataset of alert group resolution plans. The dataset of alert group resolution plans now labeled with the prioritization scores by the AI agent is used as training data for training a machine learning model to score prioritization of alert group resolution plans.

### BACKGROUND

The disclosure generally relates to artificial intelligence labeling training data for machine learning model training (e.g., CPC subclass G06F 17/00).

A security operations center (SOC) is an organizational or business unit that manages and improves overall security posture of an organization. The SOC includes security analysts, processes, and technology to detect, analyze, and respond to cybersecurity events. The technology includes security tools, such as firewalls and Security Information and Event Management (SIEM), that generate alerts. With cybercrime damage exceeding $8 trillion in 2022 and continuing to grow rapidly, the corresponding volume of alerts have induced alert fatigue in security analysts. Grouping alerts and resolving by alert group attempted to address the volume of alerts.

### BRIEF DESCRIPTION OF THE DRAWINGS

Embodiments of the disclosure may be better understood by referencing the accompanying drawings.

FIG. 1 is a diagram of an AI agent labeling training data and using the training data to train machine learning models to score prioritization of alert group resolution plans.

FIG. 2 is a flowchart of example operations for generating labeled training data for training machine learning models to score prioritization of alert group resolution plans.

FIG. 3 is a flowchart of example operations for tuning a reasoning engine of the AI agent to score prioritization of alert group resolution plans.

FIG. 4 depicts an example computer system with an AI agent for machine learning training data labeling.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### TERMINOLOGY

It is well defined that machine learning is a subfield within the field of artificial intelligence. Delineating a machine learning model and an artificial intelligence model can be more challenging. For instance, artificial intelligence models use machine learning models. A distinguishing characteristic is task specificity. An artificial intelligence model will have capabilities that are generalizable for performing multiple types of tasks. In contrast, a machine learning model will have been trained to perform a specific task, such as predicting or classifying based on a particular input. Another distinguishing characteristic is the substantially greater cost of inference by a foundation model or language model compared to the cost of running a trained machine learning model, at least in terms of compute resources and inference latency.

While various definitions exist for “AI agent,” this description relies on a basic definition that an AI agent can solve a complex problem or complete a complex task in multiple steps and has autonomy to solve a problem/task without human involvement until a final result. In this description, an AI agent is a system or software that uses a reasoning engine to perform a complex task. In this case, the complex task is labeling training data for training a machine learning model to score prioritization of alert group resolution plans. The reasoning engine is an AI model, such as a foundation model or language model. The AI agent may include the reasoning engine or access the reasoning engine via an application programming interface (API) of the reasoning engine.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### OVERVIEW

Supervised machine learning has been employed to address the volume of alerts that continue to overwhelm security analysts even with alert grouping since prioritization of alert group resolution plans is a deterministic problem. However, supervised machine learning requires training data. An artificial intelligence (AI) framework has been created to efficiently label training data for training a machine learning model to score prioritization of alert group resolution plans to aid in triage of alert groups. An AI agent uses a labeled dataset of alert group resolution plans to tune its reasoning engine to score prioritization of alert group resolution plans. The AI agent tunes its reasoning engine by employing active learning until the prioritization scoring is sufficiently accurate. Upon achieving sufficient accuracy, the AI agent scores prioritization of an unlabeled dataset of alert group resolution plans (e.g., 10,000 to 100,000 alert group resolution plans). The dataset of alert group resolution plans now labeled with the prioritization scores by the AI agent is used as training data for training a machine learning model to score prioritization of alert group resolution plans.

### Example Illustrations

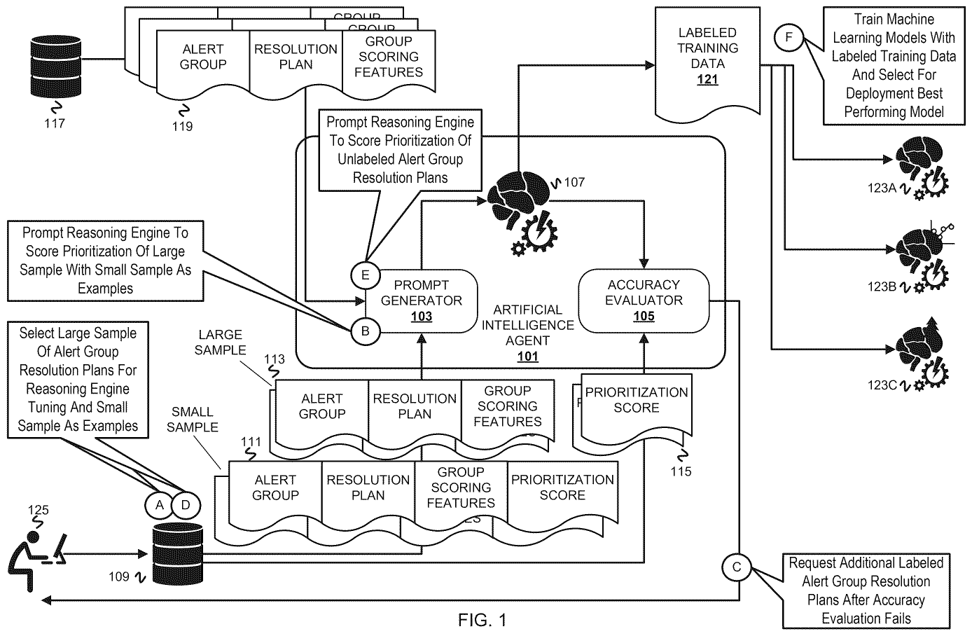

FIG. 1 is a diagram of an AI agent labeling training data and using the training data to train machine learning models to score prioritization of alert group resolution plans. An AI agent 101 includes a prompt generator 103, an accuracy evaluator 105, and a reasoning engine 107. The prompt generator 103 generates prompts that direct the reasoning engine 107 with task instructions. The accuracy evaluator 105 evaluates the scoring by the reasoning engine against ground truth provided by a domain expert(s) 125 to determine whether the reasoning engine has been tuned to be sufficiently accurate in its scoring. The AI agent 101 has access to a repository 117 and a repository 109.

The repositories 109, 117 respectively host a labeled dataset and an unlabeled dataset. The repository 117 hosts a dataset of unlabeled alert group resolution plans 119. Each of the unlabeled alert group resolution plans 119 includes a group of alerts, characteristics of the alert group corresponding to the grouping, and a resolution plan for resolving the group of alerts. Example groupings of alerts include grouping of alerts from over-privileged role across virtual machines, grouping of alerts from an over-permissive network security group that exposes cloud assets or workloads, and grouping of alerts from a vulnerable image being deployed into multiple containers or virtual machines. The group characteristics of an alert group are features for scoring prioritization of the resolution plan for the alert group. The repository 109 hosts a dataset of labeled alert group resolution plans. Similar to the alert group resolution plans in the repository 117, each entry in the dataset hosted in the repository 109 includes a group of alerts, characteristics of the alert group corresponding to the grouping, and a resolution plan for resolving the group of alerts. In addition, each labeled alert group resolution plan in the repository 109 includes a prioritization score and additional context information that has been added by a domain expert 125. The domain expert 125 or multiple domain experts have labeled the alert group resolution plans in the repository 109.

FIG. 1 is annotated with a series of letters A-F representing stages of operations, each stage corresponding to one or more operations. Although these stages are ordered for this example, the stages illustrate one example to aid in understanding this disclosure and should not be used to limit the claims. Subject matter falling within the scope of the claims can vary from what is illustrated.

At stage A, the AI agent 101 selects samples of the labeled alert group resolution plans from the repository 109 to begin tuning the reasoning engine 107. The AI agent 101 selects a large sample of labeled alert group resolution plans for the reasoning engine 107 to score prioritization and a small sample of the labeled alert group resolution plans as examples to guide the reasoning engine 107. The samples are “large” and “small” with respect to each other. For instance, the large sample can be all but 5 entries and the small sample be those 5 entries. The large sample is separated into alert group resolution plans 113 and their corresponding prioritization scores 115 (i.e., labels). The small sample includes labeled alert group resolution plans 111.

At stage B, the prompt generator 103 of the AI agent 101 prompts the reasoning engine 107 to score prioritization of the alert group resolution plans 113 in the large sample. The prompt generator 103 generates a prompt using the labeled alert group resolution plans 111 as examples in the prompt. The prompt generator 103 generates the prompt with task instructions to score the alert group resolution plans 113 and explain the reasoning for the scoring. The prompt generator 103 includes as context in the prompt an explanation of the group characteristics that are features for scoring. The prompt generator 103 can also generate the prompt with a task instruction specifying output format.

At stage C, the AI agent 101 requests from the domain expert(s) 125 additional labeled alert group resolution plans after the accuracy evaluation fails. The accuracy evaluator 105 evaluates accuracy of the scoring by the reasoning engine 107 using the prioritization scores 115 of the alert group resolution plans 113 that were scored by the reasoning engine 107. The accuracy evaluator 105 applies a configurable accuracy criterion that the scoring by the reasoning engine 107 be at least 97% accurate, for example.

At stage D, the AI agent 101 again selects samples of the labeled alert group resolution plans from the repository 109 to continue tuning the reasoning engine 107. The AI agent 101 will select the samples after confirmation that additional labeled alert group resolution plans have been obtained from the domain expert 125. As examples, the AI agent 101 can query the domain expert 125, wait for confirmation that a request for additional labeled samples has been completed, or determine whether n new entries have been added to the repository 109 since the last sampling, where n is a configurable value. The operations represented by stages B-D repeat until the accuracy evaluator 105 determines that the reasoning engine 107 has been sufficiently tuned based on its scoring satisfying the accuracy criterion.

At stage E, the AI agent 101 prompts the reasoning engine 107 to score prioritization of the unlabeled alert group resolution plans 119. After the AI agent 101 determines that the reasoning engine 107 has been tuned to accurately score prioritization, the AI agent 101 retrieves from the repository 117 the unlabeled alert group resolution plans 119 for prioritization scoring. The prompt generator 103 uses a sample of the labeled alert group resolution plans from the repository 109 as few shot examples when generating the prompt. The prompt generator 103 generates the prompt with the task instructions and context used when tuning. The reasoning engine 107 scores prioritization of the unlabeled alert group resolution plans 119 to generate labeled training data 121.

At stage F, the AI agent 101 trains machine learning models (e.g., neural networks, support vector machines, gradient boosted trees, etc.) with the labeled training data 121 and selects for deployment the best performing model. The AI agent 101 splits the labeled training data 121 into a training subset and a testing subset for performance evaluation. The AI agent 101 trains a neural network-based model 123A, a support vector machine 123B, and a gradient boosted tree 123C. The best performing one of the models 123A-123C is deployed for scoring alert group resolution plans to assist in triage of alert groups.

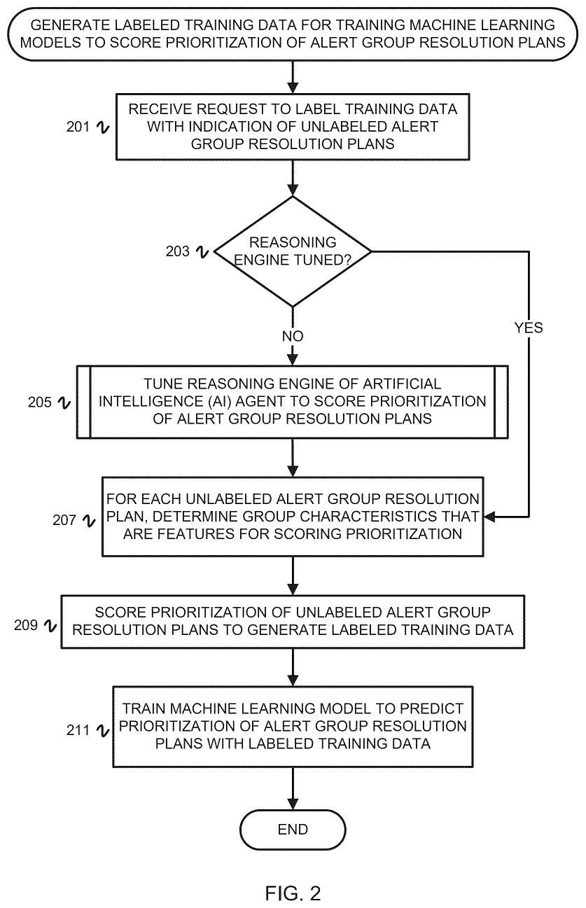

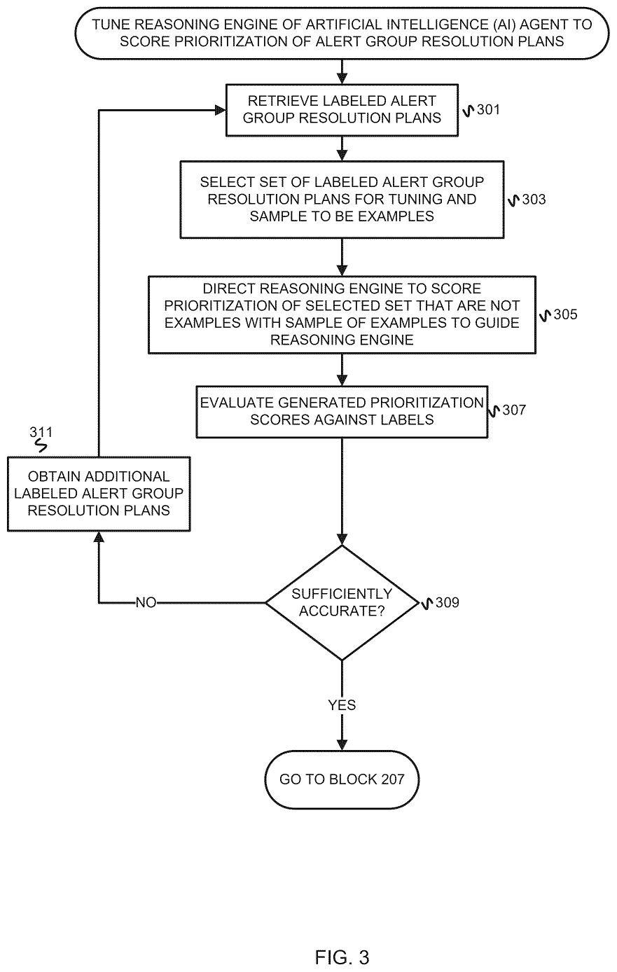

FIGS. 2-3 are flowcharts of example operations for an AI agent to label machine learning training data after tuning its reasoning engine to accurately score prioritization of alert group resolution plans. FIG. 1 depicted a prompt generator and an accuracy evaluator as components of the example AI agent. FIG. 1 did not depict other components of the AI agent or tools of the AI agent that allowed the AI agent to retrieve data from repositories or run machine learning training jobs. The organization of capabilities and/or functionality can vary as well as names. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary. The example operations of the flowcharts are described with reference to the AI agent for consistency with the FIG. 1 and ease of understanding.

FIG. 2 is a flowchart of example operations for generating labeled training data for training machine learning models to score prioritization of alert group resolution plans. An AI agent includes a front-end layer to receive requests to label training data and a tool to access specified repositories of labeled and unlabeled alert group resolution plans. The AI agent also includes a tool to run machine learning training jobs. The objective of the scoring is to prioritize resolution plans by maximal impact and minimal effort as informed by the scoring features.

At block 201, the AI agent receives a request to label training data. The request indicates a dataset of unlabeled alert group resolution plans to be labeled to generate labeled training data. The request can be from a user via a user interface, from a running process (e.g., a scheduled job), or from another AI agent that manages machine learning models, for example.

At block 203, the AI agent determines whether the reasoning engine of the AI agent is already tuned for scoring prioritization to label training data. The AI agent can maintain a flag or indicator of whether or not the reasoning engine has been tuned. The AI agent can also periodically evaluate performance of a trained machine learning model or receive indication of underperformance of a trained machine learning model and reset that indicator to trigger additional tuning of the reasoning engine. If the reasoning engine is tuned, then operational flow proceeds to block 207. Otherwise, operational flow proceeds to block 205.

At block 205, the AI agent tunes the reasoning engine to score prioritization of alert group resolution plans. The AI agent repeatedly tasks or directs the reasoning engine (e.g., a language model) to score prioritization of alert group resolution plans that have ground truth prioritization scores. When additional labeled alert group resolution plans are needed for tuning, the AI agent uses active learning. FIG. 3 provides example operations for the tuning.

At block 207, the AI agent determines group characteristics that are features for scoring prioritization. Characteristics of each group of alerts that are the basis for the grouping have previously been indicated as features for scoring prioritization. The labels of the labeled alert group resolution plans also include information from domain experts that provide additional context for the scoring. Alert group characteristics that are factors or features for scoring at least include risk factors, resolution impact, and resolution or fix simplicity. Examples of risk factors for an alert group include a maximum alert score in the alert group and criticality of an asset indicated in an alert. Examples of resolution impact factors include a quantity or count of alerts in an alert group and a count of impacted assets of an alert group. Fix simplicity can be expressed in individual components or be calculated based on those components. Examples of the components corresponding to fix simplicity include number of policies to be enforced, number of aggregate actions or steps to fix impacted assets, the types of assets impacted, the type of issues indicated in the alert group, whether the resolution involves an individual, team or multiple teams, negative impact of the resolution on an environment or application, and average time for the resolution. The AI agent may aggregate values in metadata of the alert group resolution plans to determine the scoring features, such as counting alerts and assets in an alert group. The AI agent may also normalize scoring features across alert groups within a dataset, for example, using a maximum alert score to normalize alert scoring feature values and using a maximum asset count to normalize asset count scoring feature values.

At block 209, the AI agent scores prioritization of the unlabeled alert group resolution plans to generate labeled training data. The AI agent populates a predefined prompt template with task instructions to score the prioritization of the unlabeled alert group resolution plans and to explain it reasoning. The AI agent also includes for context an explanation of the prioritization scoring features. Below is an example prompt template.
““You are a cloud security expert knowledgeable on different cloud services, asset types, vulnerabilities, and other cloud environment related entities. Your task is to score prioritization of the alert group resolution plans based on the scoring features provided.
The scoring features include:
<identify and describe scoring features here>
Here is a set of example scored alert group resolution plans:
<Include few shot examples here>
Output format:
Score: 0-100
Explain your scoring of each alert group resolution plan.””

At block 211, the AI agent trains a machine learning model to predict prioritization of alert group resolution plans with the labeled training data. The AI agent is associated with a tool that can run a training job on one or more machine learning models. The AI agent can configure hyperparameter optimization and split the test data based on configuration and/or prompting its reasoning engine for training parameters based on a description of the model and the labeled training data.

FIG. 3 is a flowchart of example operations for tuning a reasoning engine of the AI agent to score prioritization of alert group resolution plans. This tuning or fine-tuning adapts a pre-trained model to the scoring task. Fine-tuning can include instruction tuning and additional techniques, such as active learning. This example uses instruction tuning and active learning. Fine-tuning implementations can vary depending upon the reasoning engine and preferences.

At block 301, the AI agent retrieves labeled alert group resolution plans for tuning the reasoning engine. The AI agent may retrieve a predefined quantity of the labeled alert group resolution plans or all available labeled alert group resolution plans. In some cases, additional labeled alert group resolution plans are added while the AI agent is retrieving labeled alert group resolution plans and tuning the reasoning engine.

At block 303, the AI agent selects a set of labeled alert group resolution plans for tuning and samples from the selected set a sample to be examples. The sampling can be according to stratified sampling. Assume four prioritization categories of alert group resolution plans: critical, high, medium, and low. The AI agent would sample from each category to be an example. Below are examples of labels including prioritization category/class and additional context across the categories.

| Critical | High |
|---|---|
| { | { |
| ″Risk″: { | ″Risk″: { |
| ″Max Alert Risk Score″: 99, | ″Max Alert Risk Score″: 85, |
| ″Max Asset Criticality″: 4, | ″Max Asset Criticality″: 4, |
| ″Risk Reduction Factor″: 0.05 | ″Risk Reduction Factor″: 0.07 |
| }, | }, |
| ″Resolution Impact Factors″: { | ″Resolution Impact Factors″: { |
| ″Alert Count Normalized″: 0.1, | ″Alert Count Normalized″: 0.1, |
| ″Asset Count Normalized″: 0.1 | ″Asset Count Normalized″: 0.1 |
| }, | }, |
| ″Resolution Complexity″: { | ″Resolution Complexity″: { |
| ″Policy Count″: 2 | ″Policy Count″: 5 |
| }, | }, |
| “Additional Context”: {“role | “Additional Context”: {“role |
| criticality”: High, “critical assets”: | criticality”: High, “critical assets”: |
| “multiple”, “Vulnerabilities”: | “few”, “Vulnerabilities”: |
| “multiple”}} | “multiple”}} |

| Medium | Low |
|---|---|
| { | { |
| ″Risk″: { | ″Risk″: { |
| ″Max Alert Risk Score″: 78, | ″Max Alert Risk Score″: 50, |
| ″Max Asset Criticality″: 3, | ″Max Asset Criticality″: 1, |
| ″Risk Reduction Factor″: 0.01 | ″Risk Reduction Factor″: 0.001 |
| }, | }, |
| ″Resolution Impact Factors″: { | ″Resolution Impact Factors″: { |
| ″Alert Count Normalized″: 0.02, | ″Alert Count Normalized″: 0.01, |
| ″Asset Count Normalized″: 0.02 | ″Asset Count Normalized″: 0.01 |
| }, | }, |
| ″Resolution Complexity″: { | ″Resolution Complexity″: { |
| ″Policy Count″: 8 | ″Policy Count″: 25 |
| }, | }, |
| “Additional Context”: {“role | “Additional Context”: {“role |
| criticality”: Medium, “critical | criticality”: Low, “critical assets”: |
| assets”: “few”, “Vulnerabilities”: | “few”, “Vulnerabilities”: “multiple”}} |
| “multiple”}} | |

At block 305, the AI agent directs the reasoning engine to score prioritization of the selected set of alert group resolution plans with the sample as examples to guide the reasoning engine. The AI agent prompts the reasoning engine as it did during fine-tuning.

At block 307, the AI agent evaluates the generated prioritization scores against the labels of the selected set of labeled alert group resolution plans. The AI agent compares the prioritization scores generated by the reasoning engine against the ground truth labels. Based on the comparison, the AI agent calculates scoring accuracy. Calculation of accuracy can vary by implementation. For instance, the AI agent may calculate accuracy strictly based on exact score matching. The AI agent may allow for deviation within a defined margin of deviation.

At block 309, the AI agent determines whether the scoring by the reasoning engine is sufficiently accurate. The AI agent determines whether the calculated accuracy satisfies an accuracy criterion or threshold. If the scoring is sufficiently accurate, then operational flow proceeds to block 207 of FIG. 2. If the scoring is not sufficiently accurate, then operational flow proceeds to block 311.

At block 311, the AI agent obtains additional labeled alert group resolution plans after determining that the prioritization scoring was not sufficiently accurate. Obtaining additional labeled alert group resolution plans can involve notifying a user that additional labeled alert group resolution plans are needed or retrieving additional labeled alert group resolution plans. For instance, each sampling of labeled alert group resolution plans does not necessarily retrieve all available labeled alert group resolution plans. The AI agent can retrieve subsets of the labeled alert group resolution plans for each tuning iteration and then generate a notification that additional labeled alert group resolution plans are needed when the available not yet sampled entries in the ground truth dataset are insufficient in quantity for an additional round of tuning. The AI agent can select some of the unlabeled alert group resolution plans and provide those for labeling. Operational flow returns to block 301 for selection of a different set of labeled alert group resolution plans.

### Variations

Embodiments can vary from the example illustrations described to aid in understanding the disclosure. For instance, the example illustrations refer to scoring prioritization. Embodiments can instead classify alert group resolution plans (e.g. critical, high, medium, low). Embodiments can both score and classify alert group resolution plans. Furthermore, the AI agent or another AI agent can perform data pre-processing or data preparation. As an example, an AI agent can direct or prompt its reasoning engine to determine the scoring features for a dataset of alert group resolution plans.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations represented by block 311 can be performed in parallel or concurrently with continued fine-tuning of the reasoning engine or the AI agent can wait for additional labeled alert group resolution plans. In addition, the scoring and/or classifying, whether during fine-tuning or not, can be on an individual alert group resolution plan basis for batches smaller than the entire dataset. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example but not limited to, a system, apparatus, or device, that employs one or a combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

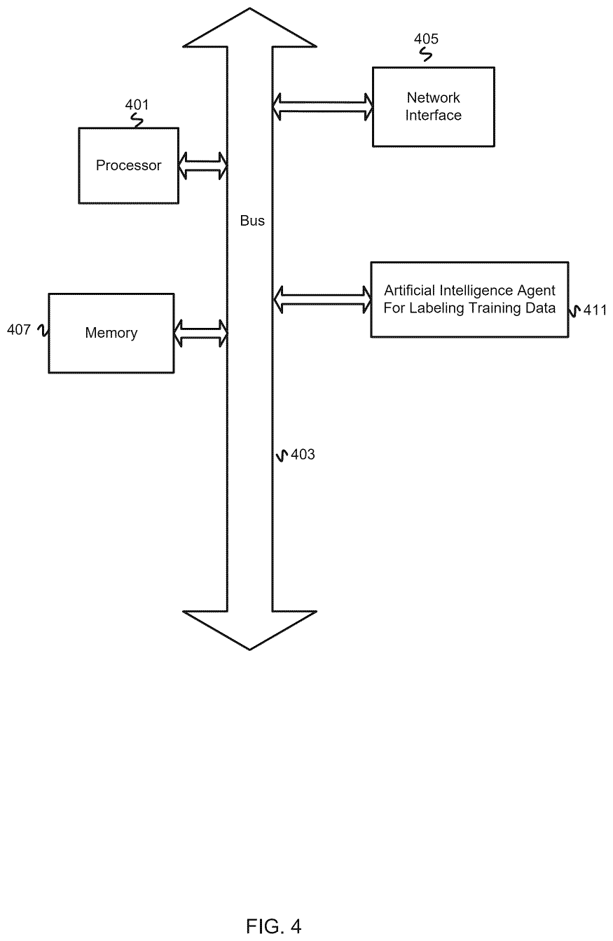

FIG. 4 depicts an example computer system with an AI agent for machine learning training data labeling. The computer system includes a processor 401 (possibly including multiple processors, multiple cores, multiple nodes, and/or implementing multi-threading, etc.). The computer system includes memory 407. The memory 407 may be system memory or any one or more of the above already described possible realizations of machine-readable media. The computer system also includes a bus 403 and a network interface 405. The system also includes an AI agent 411. The AI agent 411 fine-tunes it reasoning engine to accurately score and/or classify alert group resolution plans. The AI agent 411 interacts with a domain expert to obtain additional labeled alert group resolution plans until the reasoning engine scoring and/or classifying satisfies a fine-tuning criterion. After the fine-tuning criterion is satisfied, the AI agent 411 can score and/or classify a dataset of unlabeled alert group resolution plans, yielding a labeled training dataset. The AI agent 411 can use a tool to run a training job that trains one or more machine learning models to score and/or classify alert group resolution plans using the labeled training dataset. After training, the machine learning model can be deployed to aid security analysts in prioritizing or triaging alert groups for resolution. The AI agent 411 can be within a larger agentic AI system that generates different labeled training data to train machine learning models on different tasks. Any one of the previously described functionalities may be partially (or entirely) implemented in hardware and/or on the processor 401. For example, the functionality may be implemented with an application specific integrated circuit, in logic implemented in the processor 401, in a co-processor on a peripheral device or card, etc. Further, realizations may include fewer or additional components not illustrated in FIG. 4 (e.g., video cards, audio cards, additional network interfaces, peripheral devices, etc.). The processor 401 and the network interface 405 are coupled to the bus 403. Although illustrated as being coupled to the bus 403, the memory 407 may be coupled to the processor 401.

1. A method comprising:
labeling a first plurality of alert group resolution plans with prioritization values to generate labeled training data for a first machine learning model, wherein the labeling comprises,
an artificial intelligence (AI) agent tuning its reasoning engine to determine prioritization values with active learning using a second plurality of alert group resolution plans until an accuracy criterion is satisfied, wherein the second plurality of alert group resolution plans have ground truth prioritization values; and
after the accuracy criterion is satisfied, the AI agent labeling the first plurality of alert group resolution plans with prioritization values; and
training the first machine learning model with the labeled first plurality of alert group resolution plans to predict prioritization values for alert group resolution plans.

2. The method of claim 1, wherein the AI agent tuning its reasoning engine to determine prioritization values comprises the AI agent prompting the reasoning engine to determine prioritization values for a first subset of the second plurality of alert group resolution plans and using a second subset of the second plurality of alert group resolution plans as few shot examples.

3. The method of claim 2, wherein the AI agent prompting the reasoning engine comprises the AI agent generating a prompt comprising a task instruction to the reasoning engine to generate prioritization values for the first subset of the second plurality of alert group resolution plans and, as context, descriptions of group characteristics for alert groups.

4. The method of claim 1, wherein the AI agent tuning its reasoning engine to determine prioritization values with active learning until the accuracy criterion is satisfied comprises obtaining additional alert group resolution plans with ground truth prioritization values when the accuracy criterion is not satisfied.

5. The method of claim 4, wherein obtaining additional alert group resolution plans with ground truth prioritization values comprises selecting a sample of the first plurality of alert group resolution plans and prompting a domain expert to label the sample with ground truth prioritization values.

6. The method of claim 1, wherein the AI agent labeling the first plurality of alert group resolution plans with prioritization values comprises the AI agent prompting the reasoning engine to generate prioritization values for the first plurality of alert group resolution plans.

7. The method of claim 1, wherein training the first machine learning model with the labeled first plurality of alert group resolution plans comprises the AI agent triggering a job to train the first machine learning model.

8. The method of claim 7, further comprising the AI agent triggering the job or a second job to train a second machine learning model with the labeled first plurality of alert group resolution plans, the AI agent evaluating performance of the first and the second machine learning models, and the AI agent selecting for deployment the better performing machine learning model.

9. The method of claim 1, wherein the AI agent tuning the reasoning engine to determine prioritization values using the second plurality of alert group resolution plans comprises partitioning the second plurality of alert group resolution plans into subgroups and tuning the reasoning engine on the subgroups.

10. A non-transitory, machine-readable medium having stored thereon program code comprising instructions to:
tune a language model to determine prioritization values based, at least in part, on active learning using a first plurality of alert group resolution plans until an accuracy criterion is satisfied, wherein the first plurality of alert group resolution plans have ground truth prioritization values;
after the accuracy criterion is satisfied, prompt the tuned language model to label a second plurality of alert group resolution plans with prioritization values to generate labeled training data; and
train a first machine learning model with the labeled training data to predict prioritization values for alert group resolution plans.

11. The non-transitory, machine-readable medium of claim 10, wherein the instructions to tune the language model to determine prioritization values comprise instructions to prompt the language model to determine prioritization values for a first subset of the first plurality of alert group resolution plans and use a second subset of the first plurality of alert group resolution plans as few shot examples.

12. The non-transitory, machine-readable medium of claim 11, wherein the instructions to prompt the language model comprise instructions to generate a prompt comprising a task instruction to the language model to generate prioritization values for the first subset of the first plurality of alert group resolution plans and, as context, descriptions of group characteristics for alert groups.

13. The non-transitory, machine-readable medium of claim 10, wherein the instructions to tune the language model to determine prioritization values based, at least in part, on active learning comprise instructions to obtain additional alert group resolution plans with ground truth prioritization values when the accuracy criterion is not satisfied.

14. The non-transitory, machine-readable medium of claim 10, wherein the instructions to train the first machine learning model with the labeled training data comprise instructions to trigger a job or jobs to train the first machine learning model and at least a second machine learning model and to evaluate performance of the machine learning models, and the program code further comprising instructions to select for deployment the better performing machine learning model.

15. The non-transitory, machine-readable medium of claim 10, wherein the instructions to tune the language model to determine prioritization values using the first plurality of alert group resolution plans comprise instructions to partition the first plurality of alert group resolution plans into subgroups and tune the language model on the subgroups.

16. An apparatus comprising:
a processor; and
a machine-readable medium having stored thereon instructions executable by the processor to cause the apparatus to,
tune a language model to determine prioritization values based, at least in part, on active learning using a first plurality of alert group resolution plans until an accuracy criterion is satisfied, wherein the first plurality of alert group resolution plans have ground truth prioritization values;
after the accuracy criterion is satisfied, prompt the tuned language model to label a second plurality of alert group resolution plans with prioritization values to generate labeled training data; and
train a first machine learning model with the labeled training data to predict prioritization values for alert group resolution plans.

17. The apparatus of claim 16, wherein the instructions to tune the language model to determine prioritization values comprise instructions executable by the processor to cause the apparatus to prompt the language model to determine prioritization values for a first subset of the first plurality of alert group resolution plans and use a second subset of the first plurality of alert group resolution plans as few shot examples.

18. The apparatus of claim 17, wherein the instructions to prompt the language model comprise instructions executable by the processor to cause the apparatus to generate a prompt comprising a task instruction to the language model to generate prioritization values for the first subset of the first plurality of alert group resolution plans and, as context, descriptions of group characteristics for alert groups.

19. The apparatus of claim 16, wherein the instructions to tune the language model to determine prioritization values based, at least in part, on active learning comprise instructions executable by the processor to cause the apparatus to obtain additional alert group resolution plans with ground truth prioritization values when the accuracy criterion is not satisfied.

20. The apparatus of claim 16, wherein the instructions to train the first machine learning model with the labeled training data comprise instructions executable by the processor to cause the apparatus to trigger a job or jobs to train the first machine learning model and at least a second machine learning model and to evaluate performance of the machine learning models, and the machine-readable medium further comprising instructions executable by the processor to cause the apparatus to select for deployment the better performing machine learning model.
